(19) United States
(12) Patent Application Publication
(10) Pub. No.: US 2024/0190288 A1
(43) Pub. Date: Jun. 13, 2024

(54) Battery Replacement Apparatus

(71) Applicant: TOYOTA JIDOSHA KABUSHIKI KAISHA, Toyota-shi Aichi-Ken (JP)

(72) Inventors: Soshiro MURATA, Toyota-shi Aichi-Ken (JP); Hiroshi UMENO, Nisshin-shi Aichi-ken (JP); Takahiro NOMURA, Okazaki-shi Aichi-Ken (JP); Yuya ONOZUKA, Toyota-shi Aichi-Ken (JP)

(73) Assignee: TOYOTA JIDOSHA KABUSHIKI KAISHA, Toyota-shi Aichi-Ken (JP)

(21) Appl. No.: 18/529,230

(22) Filed: Dec. 5, 2023

(30) Foreign Application Priority Data
Dec. 9, 2022 (JP) 2022-197352

(51) Int. Cl. B60L 53/80; B60K 1/04

(52) U.S. Cl. CPC B60L 53/80; B60K 1/04; B60K 2001/0472

(57) ABSTRACT

A battery replacement apparatus includes: a battery replacement station which has a first stop area and a second stop area and in which removal of a first battery from a vehicle body and attachment of a second battery to the vehicle body are to be performed; a removal device that is provided below the first stop area and removes the first battery from the vehicle body stopped in the first stop area; and an attachment device that is provided below the second stop area and attaches the second battery to the vehicle body stopped in the second stop area.

This nonprovisional application is based on Japanese Patent Application No. 2022-197352 filed on Dec. 9, 2022 with the Japan Patent Office, the entire contents of which are hereby incorporated by reference.

### BACKGROUND

### Field

The present disclosure relates to a battery replacement apparatus.

### Description of the Background Art

Conventionally, there has been known a vehicle in which a battery can be replaced, for example, Japanese Patent Application Laid-Open No. 2012-192782 discloses a battery replacement apparatus in which a battery attached to a lower portion of a vehicle body can be replaced from below the vehicle body. One support plate for supporting the battery electric vehicle is provided on the floor of the battery replacement apparatus. The support plate constitutes a vehicle stop.

### SUMMARY

In the battery replacement apparatus described in Japanese Patent Application Laid-Open No. 2012-192782, since the battery is replaced one by one on the support plate, the next vehicle cannot enter the battery replacement apparatus until the vehicle that has previously entered the battery replacement apparatus exits the battery replacement apparatus. Therefore, it takes longer time to replace the batteries of the two vehicles.

It is an object of the present disclosure to provide a battery replacement apparatus that enables reduction of the time required for replacing batteries of two vehicles.

A battery replacement apparatus according to one aspect of the present disclosure is a battery replacement apparatus for replacing a used first battery attached to a vehicle body of an electrically powered vehicle with a charged second battery, and the battery replacement apparatus includes: a battery replacement station which includes a first stop area where the electrically powered vehicle is to be stopped and a second stop area located at a position separated from the first stop area and in which removal of the first battery from the vehicle body and attachment of the second battery to the vehicle body are to be performed; a removal device that is provided below the first stop area and removes the first battery from the vehicle body stopped in the first stop area; and an attachment device that is provided below the second stop area and attaches the second battery to the vehicle body stopped in the second stop area.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows a battery replacement apparatus according to an embodiment of the present disclosure.

FIG. 2 is a plan view schematically showing a vehicle stop area and a moving unit in the battery replacement apparatus.

FIG. 3 is a view schematically showing a configuration of a battery mounting table.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and the description thereof will not be repeated.

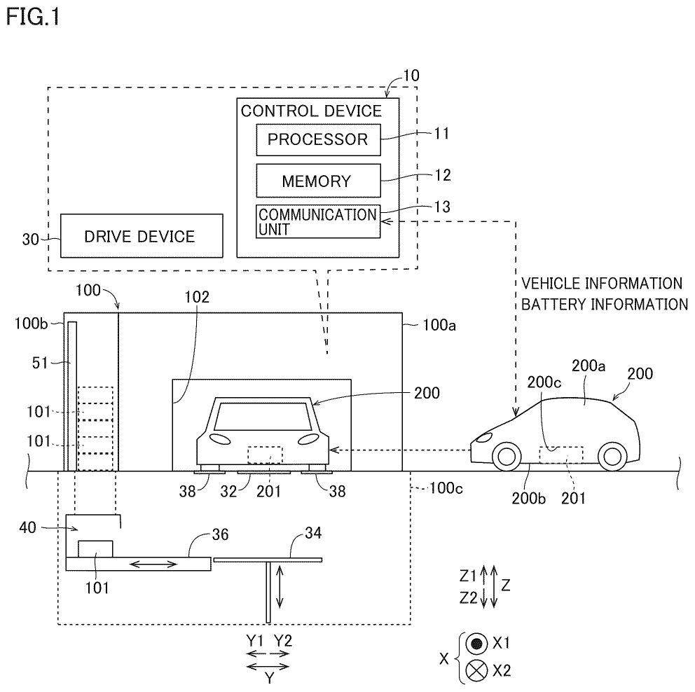

FIG. 1 is a diagram showing a battery replacement apparatus 100 and an electrically powered vehicle 200 according to the present embodiment. The battery replacement apparatus 100 is a device for replacing a battery (used battery) 201 attached to the electrically powered vehicle 200 with a charged battery (new battery) 101. The battery 201 and the battery 101 are examples of the “first battery” and the “second battery” of the present disclosure, respectively.

### (Configuration of Electrically Powered Vehicle)

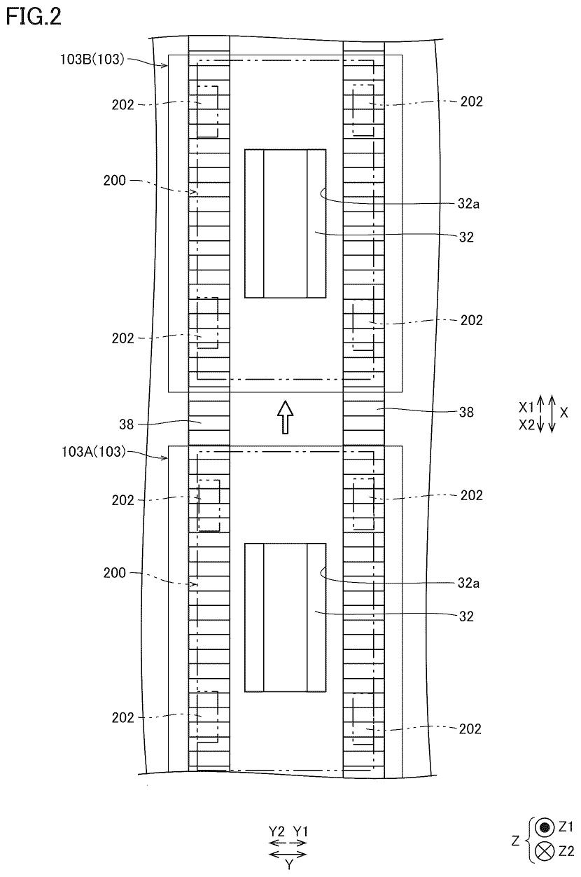

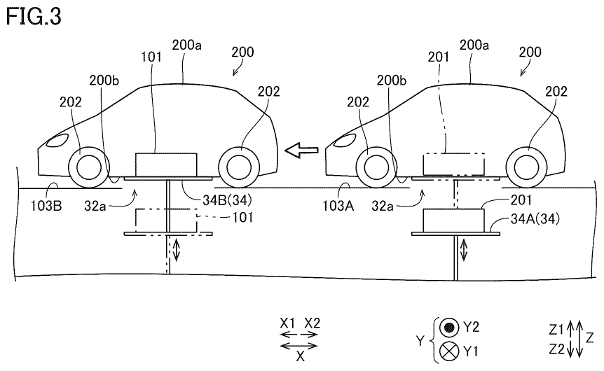

As shown in FIGS. 2 and 3, the electrically powered vehicle 200 has wheels 202. As shown in FIG. 1, the vehicle body 200a of the electrically powered vehicle 200 has a mounting portion 200c on which the batteries 101 and 201 can be mounted. The mounting portion 200c opens downward. The mounting portion 200c has a shape recessed upward from the lower surface 200b of the vehicle body 200a. The batteries 101 and 201 are attachable to and detachable from the mounting portion 200c from below. Specifically, the batteries 101 and 201 are fastened to the mounting portion 200c by fastening members such as bolts.

### (Configuration of Battery Replacement Apparatus)

Next, the battery replacement apparatus 100 will be described. As shown in FIG. 1, the battery replacement apparatus 100 includes a battery replacement station 100a, a storage 100b, and an underfloor area 100c.

The battery replacement station 100a is a station in which the battery 201 is detached from the electrically powered vehicle 200 and the battery 101 is attached to the electrically powered vehicle 200. The battery replacement station 100a is provided with an entrance/exit 102 for the electrically powered vehicle 200 to enter/exit.

Two or more electrically powered vehicles 200 can be stopped in the battery replacement station 100a. In the present embodiment, as shown in FIGS. 2 and 3, the battery replacement station 100a is provided with two vehicle stop areas 103A and 103B. The two vehicle stop areas 103A and 103B are arranged linearly in the traveling direction of the electrically powered vehicle 200. The two vehicle stop areas 103A and 103B have a first stop area 103A provided at a position close to the entrance of the battery replacement station 100a and a second stop area 103B provided in front of the first stop area 103A. The electrically powered vehicle 200 stops in the vehicle stop areas 103A and 103B such that the front-rear direction (travel direction) is the X direction and the left-right direction is the Y direction. As described later, the used battery 201 is detached from the vehicle body 200a in the first stop area 103A, and the charged battery 101 is attached to the vehicle body 200a in the second stop area 103B. The number of vehicle stop areas is not limited to two, and the arrangement of each stop area is not limited to linear.

The storage 100b stores the charged battery 101. The storage 100b is provided in parallel with the battery replacement station 100a. A charging facility 51 capable of charging the battery 201 removed from the electrically powered vehicle 200 is provided in the storage 100b. The battery 201 is charged by the charging facility 51 in the storage 100b. The battery 101 charged in the storage 100b, that is, the charged battery 101 is moved to the temporary placement site 40 provided in the underfloor area 100c, and then conveyed to the electrically powered vehicle 200.

The underfloor area 100c is provided below the battery replacement station 100a and the storage 100b. The underfloor area 100c is provided with a battery mounting table 34, a transport unit 36, and a temporary placement site 40, which will be described later.

The battery replacement apparatus 100 includes a control device 10 and a drive device 30.

The control device 10 includes a processor 11, a memory 12, and a communication unit 13. The memory 12 stores, in addition to a program executed by the processor 11, information (e.g., map, formula, and various parameters) used by the program. As will be described in detail later, the processor 11 controls the drive device 30.

The communication unit 13 includes various communication I/Fs. The processor 11 controls the communication unit 13. The communication unit 13 communicates with a DCM or the like of the electrically powered vehicle 200. The communication unit 13 and the electrically powered vehicle 200 can perform bidirectional communication. The communication unit 13 may communicate with a mobile terminal or the like possessed by the user of the electrically powered vehicle 200.

In a state in which the electrically powered vehicle 200 is stopped in the first stop area 103A, when the user performs an operation for instructing the start of the battery replacement operation in a navigation system (not shown) of the electrically powered vehicle 200, the communication unit 13 receives an instruction signal for starting the battery replacement operation from the electrically powered vehicle 200. The processor 11 starts the control of the battery replacement operation based on the reception of the instruction signal by the communication unit 13.

The drive device 30 includes a shutter 32, a battery mounting table 34, a transport unit 36, and a moving unit 38.

As shown in FIGS. 2 and 3, the shutter 32 is provided in each of the stop areas 103A and 103B. The shutter 32 is configured to be able to open and close an opening 32a (see FIGS. 2 and 3) formed in the floor of each of the stop areas 103A and 103B. The shutter 32 can be switched between a state in which the opening 32a is opened and a state in which the opening 32a is closed. In FIG. 3, illustration of the shutter 32 is omitted.

The battery mounting table 34 is disposed below the battery replacement station 100a, more specifically, below the opening 32a of each shutter 32. Each battery mounting table 34 can mount the batteries 101 and 201 and can move in the vertical direction. Each battery mounting table 34 includes a locking/unlocking tool (not shown) capable of locking and unlocking a fastening member (a bolt or the like) for fastening the batteries 101 and 201 to the mounting portion 200c.

As shown in FIG. 3, the battery mounting table 34 provided below the first stop area 103A removes the used battery 201 from the vehicle body 200a of the electrically powered vehicle 200 stopped in the first stop area 103A. The charged battery 101 is attached to the vehicle body 200a stopped in the second stop area 103B by the battery mounting table 34 provided below the second stop area 103B. That is, the battery mounting table 34 provided below the first stop area 103A constitutes a removal device 34A (see FIG. 3) for removing the battery 201 from the vehicle body 200a of the electrically powered vehicle 200 stopped in the first stop area 103A, and the battery mounting table 34 provided below the second stop area 103B constitutes an attachment device 34B (see FIG. 3) for attaching the battery 101 to the vehicle body 200a of the electrically powered vehicle 200 stopped in the second stop area 103B.

The transport unit 36 is capable of conveying the used battery 201 removed from the vehicle body 200a from the battery mounting table 34 toward the storage 100b, and conveying the charged battery 101 stored in the storage 100b toward the battery mounting table 34. Specifically, a temporary placement site 40 (see FIG. 1) for temporarily placing the batteries 101 and 201 is provided in the underfloor area 100c, and the transport unit 36 can transport the used battery 201 from the battery mounting table 34 toward the temporary placement site 40, and can transport the charged battery 101 from the temporary placement site 40 toward the battery mounting table 34. More specifically, the transport unit 36 includes a first transport element (not shown) that transports the battery 201 removed from the vehicle body 200a in the first stop area 103A from the battery mounting table 34 (removal device 34A) positioned below the first stop area 103A toward the temporary placement site 40, and a second transport element (not shown) that transports the charged battery 101 from the temporary placement site 40 toward the battery mounting table 34 (attachment device 34B) positioned below the second stop area 103B. The transport unit 36 may be of a belt conveyor type, for example.

The moving unit 38 is provided in the battery replacement station 100a, and moves the electrically powered vehicle 200. The moving unit 38 moves the vehicle body 200a of the electrically powered vehicle 200 from which the used battery 201 is detached in the first stop area 103A from the first stop area 103A to the second stop area 103B. As shown in FIG. 2, the moving unit 38 has a shape extending linearly. However, the shape of the moving unit 38 in plan view is appropriately set based on the position of the first stop area 103A, the position of the second stop area 103B, the moving direction of the electrically powered vehicle 200 in the battery replacement station 100a, and the like. The moving unit 38 includes a belt conveyor provided on the floor of the battery replacement station 100a. In FIG. 3, illustration of the moving unit 38 is omitted.

### (Battery Replacement Method)

Next, a battery replacement method using the battery replacement apparatus 100 will be described.

### [Transmission of Vehicle Information and the Like: Electrically Powered Vehicle]

First, the electrically powered vehicle 200 transmits information about the electrically powered vehicle 200 and information about the battery 201 to the communication unit 13 of the battery replacement apparatus 100. For example, when an operation of transmitting the above information is performed in a navigation system (not shown) of the electrically powered vehicle 200, the above information is transmitted to the communication unit 13. The electrically powered vehicle 200 transmits the above information before entering the battery replacement apparatus 100. The above information may be transmitted after the electrically powered vehicle 200 has entered the battery replacement apparatus 100.

### [Acquisition of Vehicle Information and the Like: Battery Replacement Apparatus]

Next, the communication unit 13 of the battery replacement apparatus 100 acquires information on the electrically powered vehicle 200 and information on the battery 201 transmitted from the electrically powered vehicle 200 by communication. The acquired information is stored in the memory 12 (see FIG. 1).

The communication unit 13 may also acquire information on the capacity (charge capacity) of the battery 201 and the SOC (State Of Charge) of the battery 201.

### [Transmission of an Instruction Signal for Battery Replacement Work: Electrically Powered Vehicle]

Next, the electrically powered vehicle 200 stopped in the vehicle stop area transmits an instruction signal for starting the battery replacement operation to the communication unit 13.

### [Reception of an Instruction Signal for Battery Replacement Work: Battery Replacement Apparatus]

Next, the communication unit 13 receives the instruction signal transmitted from the electrically powered vehicle 200. After receiving the instruction signal, the processor 11 may transmit an instruction message or the like for turning off the ignition power supply to the user of the electrically powered vehicle 200 through the communication unit 13.

### [Control of Vehicle Position: Battery Replacement Apparatus]

Next, the processor 11 adjusts the position of the electrically powered vehicle 200 in the first stop area 103A based on the information (vehicle information and battery information) acquired through the communication unit 13. The position of the electrically powered vehicle 200 is acquired by a sensor or the like (not shown).

Thus, the position and orientation of the vehicle body 200a in the horizontal direction are adjusted, and the position and orientation of the battery 201 in the horizontal direction are adjusted. As a result, the battery 201 is moved to a predetermined position above the opening 32a of the shutter 32.

[Removal of the Battery after Use: Battery Replacement Apparatus]

Next, the battery 201 after use is detached from the vehicle body 200a of the electrically powered vehicle 200 stopped in the first stop area 103A. First, the processor 11 opens the shutter 32, and raises the battery mounting table 34 (removal device 34A). As a result, the battery mounting table 34 is positioned with respect to the electrically powered vehicle 200 (battery 201).

Next, the processor 11 drives (rotates) a locking/unlocking tool (not shown) for rotating a fastening member for connecting the battery to the mounting portion 200c. Thereby, the fastening member is unlocked. As a result, the battery 201 is detached from the vehicle body 200a and placed on the removal device 34A.

[Transportation of the Battery after Use to the Storage: Battery Replacement Apparatus]

Next, the battery 201 removed from the vehicle body 200a is conveyed to the storage 100b. First, the processor 11 lowers the removal device 34A on which the battery 201 is mounted to the height position of the first transport element of the transport unit 36. Subsequently, the processor 11 drives a roller portion (not shown) of the removal device 34A so that the battery 201 moves in the storage direction (Y1 direction) on the removal device 34A. Thus, the battery 201 mounted on the removal device 34A moves from the removal device 34A to the first transport element. The battery 201 is transported to the temporary placement site 40 by the first transport element, and then stored in the storage 100b. The used battery 201 stored in the storage 100b is charged by the charging facility 51.

### [Transportation of the Charged Battery to a Battery Mounting Table: Battery Replacement Apparatus]

Next, the processor 11 conveys the charged battery 101 stored in the storage 100b to the attachment device 34B. Specifically, after the processor 11 conveys the battery 101 from the storage 100b to the temporary placement site 40 in the underfloor area 100c, the processor 11 moves the battery 101 from the temporary placement site 40 to the attachment device 34B positioned below the second stop area 103B by driving the second transport element of the transport unit 36 in the transport direction (Y2 direction). When the battery 101 moves from the second transport element to the attachment device 34B, the processor 11 drives the roller portion such that the battery 101 moves along the transport direction on the attachment device 34B. As a result, the battery 101 stops at a predetermined position on the attachment device 34B.

### [Attachment of Charged Battery: Battery Replacement Apparatus]

Next, the processor 11 performs control of attaching the charged battery 101 to the vehicle body 200a. Specifically, the processor 11 raises the attachment device 34B. In this state, the processor 11 drives (rotates) the locking/unlocking tool. Thereby, the fastening member is locked. When it is detected that all the fastening members are locked, the vehicle body side connector 204 and the battery side connector 104 are locked. As a result, the mounting of the charged battery 101 to the vehicle body 200a is completed.

When the processor 11 detects that an abnormality, a defect, or the like occurs in the second stop area 103B during the attachment of the charged battery 101 by the attachment device 34B to the vehicle body 200a, and when the removal device 34A is in the first stop area 103A during the removal of the battery 201 after use from the vehicle body 200a, the processor 11 stops the removal of the battery 201 by the removal device 34A in the first stop area 103A and causes the removal device 34A to attach the battery 201 to the vehicle body 200a again.

### [Retraction of the Battery Mounting Table and the Raising/Lowering Unit: Battery Replacement Apparatus]

Next, the processor 11 lowers the attachment device 34B and retracts the attachment device 34B from the electrically powered vehicle 200. Thereafter, the processor 11 closes the shutter 32.

### [Notification of Completion of Battery Replacement Work: Battery Replacement Apparatus]

Next, the processor 11 notifies the electrically powered vehicle 200 of the completion of the battery replacement operation through the communication unit 13.

### [Reception of the Notification of Completion of Battery Replacement Work: Electrically Powered Vehicle]

Then, the electrically powered vehicle 200 receives the notification transmitted from the communication unit 13 of the battery replacement apparatus 100. Thus, the electrically powered vehicle 200 is brought into a state in which the ignition power supply can be turned on. Thereafter, the process ends.

In the above embodiment, the position of the drive device 30 is adjusted based on the information about each of the electrically powered vehicle 200 and the battery 201, but the present disclosure is not limited thereto. The position of the drive device 30 may be adjusted based on information about either the electrically powered vehicle 200 or the battery 201.

As described above, in the electrically powered vehicle 200 according to the present embodiment, since the battery 201 after use is detached from the vehicle body 200a by the removal device 34A in the first stop area 103A and the charged battery 101 is attached to the vehicle body 200a by the attachment device 34B in the second stop area 103B, during attachment of the charged battery 101 to the vehicle body 200a of the first electrically powered vehicle 200 in the second stop area 103B, the battery 201 can be detached from the vehicle body 200a of the second electrically powered vehicle 200 in the first stop area 103A. Therefore, the time required for the battery replacement of each of the two electrically powered vehicles 200 is shortened.

It will be appreciated by those skilled in the art that the exemplary embodiments described above are specific examples of the aspects described below.

### [Aspect 1]

A battery replacement apparatus for replacing a used first battery attached to a vehicle body of an electrically powered vehicle with a charged second battery, the battery replacement apparatus comprising:
a battery replacement station which includes a first stop area where the electrically powered vehicle is to be stopped and a second stop area located at a position separated from the first stop area and in which removal of the first battery from the vehicle body and attachment of the second battery to the vehicle body are to be performed;
a removal device that is provided below the first stop area and removes the first battery from the vehicle body stopped in the first stop area; and
an attachment device that is provided below the second stop area and attaches the second battery to the vehicle body stopped in the second stop area.

In this battery replacement apparatus, the first battery is removed from the vehicle body by the removal device in the first stop area and the second battery is attached to the vehicle body by the attachment device in the second stop area, and therefore, during attachment of the second battery to the vehicle body of the first vehicle in the second stop area, the first battery can be removed from the vehicle body of the second vehicle in the first stop area. Thus, the time required for replacing the battery of each of the two vehicles is shortened.

### [Aspect 2]

The battery replacement apparatus according to Aspect 1, further comprising a moving unit that moves the vehicle body from the first stop area to the second stop area.

In this aspect, the vehicle body from which the battery is removed in the first stop area and which has accordingly lost the motive power can be moved to the second stop area.

### [Aspect 3]

The battery replacement apparatus according to Aspect 1 or 2, further comprising a control device that controls the removal device and the attachment device, wherein
when the control device detects occurrence of abnormality during attachment, by the attachment device, of the second battery to the vehicle body in the second stop area, while the removal device is removing the first battery from the vehicle body in the first stop area, the control device causes the removal device to stop removing the first battery in the first stop area and causes the removal device to attach the first battery to the vehicle body again.

In this aspect, the second vehicle stopped in the first stop area can be retracted from the battery replacement station. Specifically, when abnormality occurs during attachment of the battery to the first vehicle in the second stop area, while the battery is removed from the second vehicle in the first stop area, the battery may not thereafter be attached to the second vehicle in the second stop area. Therefore, in this case, the removal of the battery from the second vehicle in the first stop area is stopped and the battery is attached again to the second vehicle, to thereby enable the second vehicle to be retracted from the battery replacement station.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A battery replacement apparatus for replacing a used first battery attached to a vehicle body of an electrically powered vehicle with a charged second battery, the battery replacement apparatus comprising:
a battery replacement station which includes a first stop area where the electrically powered vehicle is to be stopped and a second stop area located at a position separated from the first stop area and in which removal of the first battery from the vehicle body and attachment of the second battery to the vehicle body are to be performed;
a removal device that is provided below the first stop area and removes the first battery from the vehicle body stopped in the first stop area; and
an attachment device that is provided below the second stop area and attaches the second battery to the vehicle body stopped in the second stop area.

2. The battery replacement apparatus according to claim 1, further comprising a moving unit that moves the vehicle body from the first stop area to the second stop area.

3. The battery replacement apparatus according to claim 1, further comprising a control device that controls the removal device and the attachment device, wherein
when the control device detects occurrence of abnormality during attachment, by the attachment device, of the second battery to the vehicle body in the second stop area, while the removal device is removing the first battery from the vehicle body in the first stop area, the control device causes the removal device to stop removing the first battery in the first stop area and causes the removal device to attach the first battery to the vehicle body again.
